(19) United States
(12) Patent Application Publication
(10) Pub. No.: US 2025/0167646 A1
(43) Pub. Date: May 22, 2025

(54) SYSTEM AND MANUFACTURING METHOD FOR ASSEMBLING A LAMINATION STACK WITH A TWO-COMPONENT ADHESIVE AT LOWER TEMPERATURES

(71) Applicant: DANA ITALIA S.R.L., Arco (IT)

(72) Inventors: Davide CARPI, Caluso (IT); Michelangelo MARINI, Trento (IT); Pier Paolo RINALDI, Arco (IT)

(21) Appl. No.: 18/517,734

(22) Filed: Nov. 22, 2023

(51) Int. Cl. H02K 15/03; H02K 1/276; H02K 15/12

(52) U.S. Cl. CPC H02K 15/03; H02K 1/276; H02K 15/12; H02K 2201/09; H02K 2213/03

(57) ABSTRACT

Methods and systems are disclosed for increasing rotor rigidity without compromising magnetic parameters of a plurality of permanent magnets by manufacturing a lamination stack using a two-component adhesive. In one example, a method includes for each lamination of a plurality of laminations, applying a first component of a two-component adhesive to one side of a lamination of a rotor and a second component to an opposite side of the lamination, stacking the plurality of laminations such that keyways and cavities of each of the plurality of laminations are aligned to assemble the lamination stack, inserting and positioning magnets in slots of the lamination stack and binding the magnets in their respective slots with glue, and applying pressure and temperature below demagnetization temperature of the magnets to bind the plurality of laminations together.

### TECHNICAL FIELD

The present disclosure relates generally to systems and methods for electric motors, and more specifically to lamination stacks of a rotor.

### BACKGROUND AND SUMMARY

Generally, electric motors comprise a stationary rotor and a rotatable rotor. An interaction between the magnetic fields generated by each of the stator and rotor causes the rotor to rotate. The rotor of an electric motor generally includes a shaft, a lamination stack, and a component that induces a magnetic field, such as windings, conducting structures, and permanent magnets depending on the type of electric motor. The lamination stack transmits moment to the shaft, which is usually achieved with a key along the shaft. Inactive components of the rotor and stator are fabricated from ferromagnetic material to canalize magnetic fluxes. Consequently, the inactive components may experience a variable magnetic field, which may cause eddy currents to flow in the inactive components. For bulk inactive components, the flow of eddy currents may result in overheating of the bulk inactive components, a decrease in efficiency of the motor, and failure of the motor due to local melting of the material used to fabricate the inactive components. To counteract the negative effects associated with the inactive component, the rotor and stator are constructed with lamination stacks, each lamination stack comprising a plurality of isolated metal sheets called laminations.

By implementing lamination stacks wherein the main dimension of each lamination stack is parallel to the magnetic field, an electric circuit generated by and located in the lamination stack is flattened and has a low surface when compared to the electric circuit generated by the bulk material. As such, the magnetic flux passing through a lamination stack, which may act as a virtual coil, may decrease, and thus, an intensity of the generated eddy current may decrease as well. In this way, losses due to electric resistance (e.g., from heating) are reduced. By electrically isolating the laminations and reducing the thickness of the laminations in the lamination stack, the benefits described above are enhanced.

While the lamination stack provides many benefits to the electric motor system, including a lamination stack has many drawbacks. The lamination stack provides little to no mechanical integrity in and of itself. Rather, the shaft provides the mechanical integrity of the rotor and is designed to be as compact as possible to reduce effects of eddy currents in the shaft. Thus, the shaft is relatively thin to provide torsional and bending stiffness for the electric motor system. However, the key that transmits moment to the shaft, the relative movement of the lamination with respect to the shaft, and the relative movement of the lamination with respect to other laminations in the lamination stack may introduce issues during operation of the electric motor system.

As one example, fretting in the lamination stack may damage the lamination stack itself as well as produce debris that modifies insulation conditions of the laminations. Further, damage to the lamination stack may cause the lamination stack to contact the stator, which may reduce motor efficiency. In another example, shear stress due to the laminations moving relative to other laminations in the stack may damage permanent magnets, which are fabricated from fragile alloys or materials, located in slots of the lamination. In turn, damage to the permanent magnets may compromise functionality of the motor. Since permanent magnets are integrated in high performance synchronous electric motors, such as motors integrated in electric vehicles (EV) and electrification projects associated with sustainable transport technology, it is imperative to address issues affecting the permanent magnets.

Stiffness of the rotor assembly significantly affects a dynamic response of high-performance motors and the lamination stack is integral in achieving rotor stiffness and in sustaining stresses caused by dynamic phenomena of the whole driveline. As such, reliability, integrity, and performance of the motor relies on cohesion of the lamination stack. There are many methods for packing the lamination, each method having their own advantages and drawbacks. The methods include applying a pre-load, welding, clinching, and gluing.

In some applications, compressive pre-loading with threaded nuts or similar devices is used to pack the laminations. However, compressive pre-loading relies on applying the preload to stiff plates and flat laminations, which is difficult to achieve with mass-production low-quality manufacturing methods for laminations. In other applications, welding is used to pack the laminations. Although welding provides structural integrity and stiffness to the rotor, welding is also expensive and involves material and electrical continuity between the laminations, which may decrease the motor performance. Further, clinching is used to pack the laminations in other applications. Clinching can be cheap and easily integrated in lamination manufacturing processes, but clinching does not result in cohesive performances. In contrast, gluing is a fairly easy process that increases cohesion of the lamination while keeping the laminations isolated and increases damping performances of the rotor when the rotor experiences vibrations or high frequency stresses. Nevertheless, gluing utilizes adhesives that are cured to achieve the desired mechanical performance. However, the adhesives are subjected to high temperatures while curing, which may damage the rotor. Consequently, motor performance may be reduced.

Magnets may be magnetized during manufacturing or in post-assembly. Timing of the magnetization of the magnets has different advantages and drawbacks. In particular, when assembling the magnetized magnets during manufacturing, transfer and placement of the magnetized magnets within the narrow cavities of the ferromagnetic material of the rotor is performed with caution. When the magnets are magnetized post-assembly, the magnets are inserted and positioned while in a de-magnetized state and magnetized in-situ, which simplifies the assembly process. However, the magnetization is performed on the entire rotor using a high magnetic field, introducing an additional step in the manufacturing process. Moreover, magnetization of the rotor is an energy consuming process that introduces safety concerns that increase the overall manufacturing costs and is not sustainable in all applications.

Based on the methods for packing a lamination described above, using adhesive materials and magnetizing the magnets during manufacturing provides advantages with regards to performance of the motor and implementing a simple and sustainable manufacturing process. Unfortunately, the demagnetization temperature of the magnets is not high, and the temperature to cure the adhesive of the lamination stack may exceed the demagnetization temperature of the magnets, which may damage the magnetic properties of the magnets and thus, decrease the overall performance of the motor. Current solutions include utilizing structural adhesives for lamination stacks that are activated by application of high pressure and high temperatures during the curing process. Not only is the application of high pressure and high temperature during the curing process energy consuming but it can potentially damage magnetized magnets and it is not suitable for all manufacturing processes.

In German patent application number 102021205053, Pieper et al. discloses a method for arranging and/or fastening at least one magnet of rotor of an electric machine with a two-component adhesive that is activated in response to an activation pressure being achieved. The magnet is positioned within a slot of the rotor wherein pressure is applied to activate the adhesive when the magnet is in contact with an adhesive layer comprising a first adhesive and a second adhesive and a centrifugal force is generated as the rotor rotates. The first adhesive is enclosed in a microcapsule in contact with the second adhesive. In this way, the rotor can achieve consistent electromagnetic factors and increase motor performance.

The disclosure discussed above relies on assembling the magnets by means of a two-component adhesive that is cured at lower pressures and temperatures to increase motor performance. However, the structural integrity of the rotor is significant with regards to the motor performance in addition to the assembly of the magnets within the rotor.

The inventors herein have recognized the above issues and provide approaches to at least partially address them, including a method for fabricating a rotor lamination stack comprising applying a two-component adhesive, wherein one adhesive is applied to one side of a lamination and the other adhesive is applied to another side of the lamination. In this way, the disclosure may bond a plurality of laminations with a curing process at low curing temperatures. By curing the two-component adhesive the rotor lamination stack may be fabricated with minimal energy consumption while achieving a desired rotor stiffness that increases motor performance.

The above advantages and other advantages, and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 illustrates a schematic of a vehicle including an electric motor;

FIGS. 2A and 2B illustrate schematic representations of magnets and their respective slots within a cavity of a rotor lamination and a rotor;

FIG. 3 illustrates a schematic of a rotor lamination stack of an electric motor with punches;

FIGS. 4A and 4B illustrate schematics of a first rotor lamination and a second rotor lamination according to the embodiments described herein;

FIG. 5 is a flow diagram representation of a manufacturing process for assembling a rotor according to the embodiments described herein; and

FIG. 6 is a timing diagram of a manufacturing process for assembling a rotor according to the embodiments described herein.

### DETAILED DESCRIPTION

The methods and systems described herein relate to a manufacturing process for assembling a rotor lamination stack for an electric motor, the rotor lamination stack having increased structural integrity. In particular, systems and methods are provided for manufacturing the rotor lamination stack by curing a two-component adhesive coating the laminations that comprise the rotor lamination stack at higher pressures and lower temperatures. In this way, the efficiency of the motor may increase.

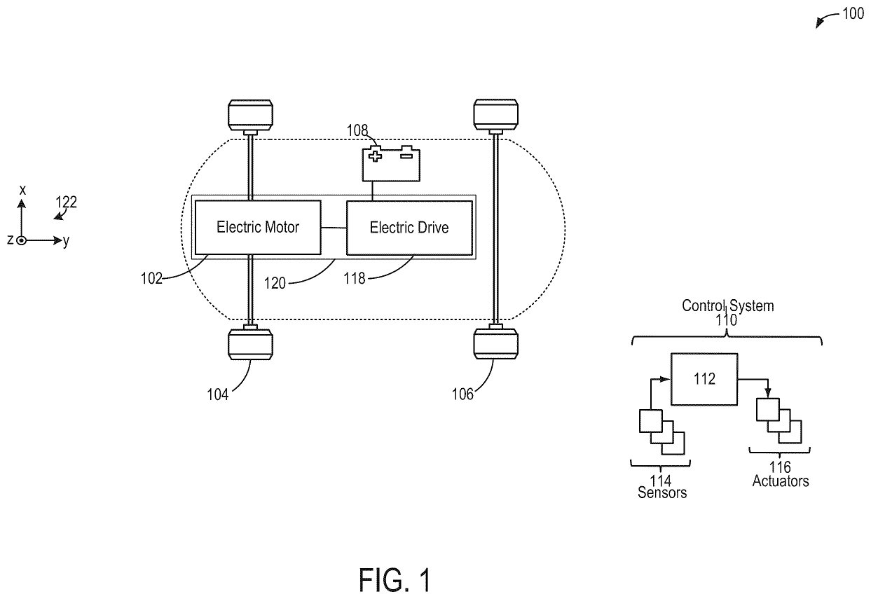

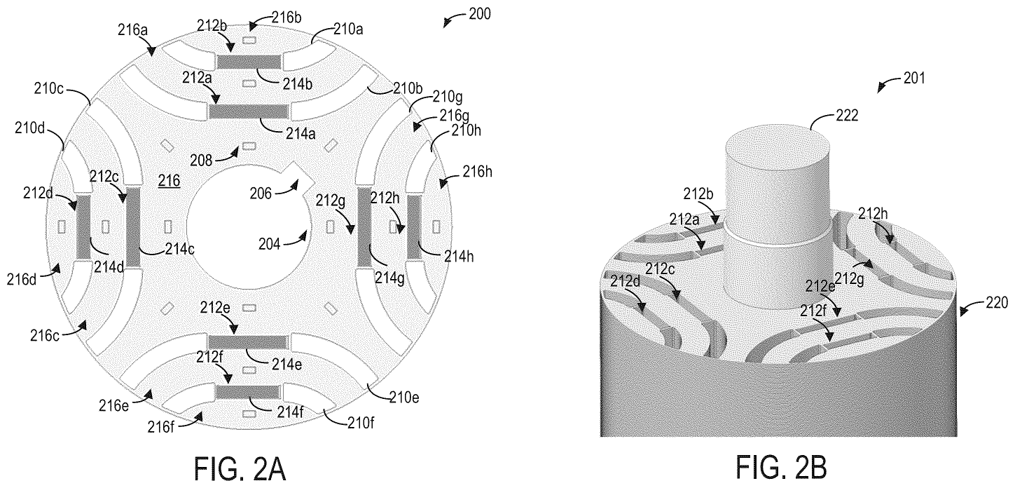

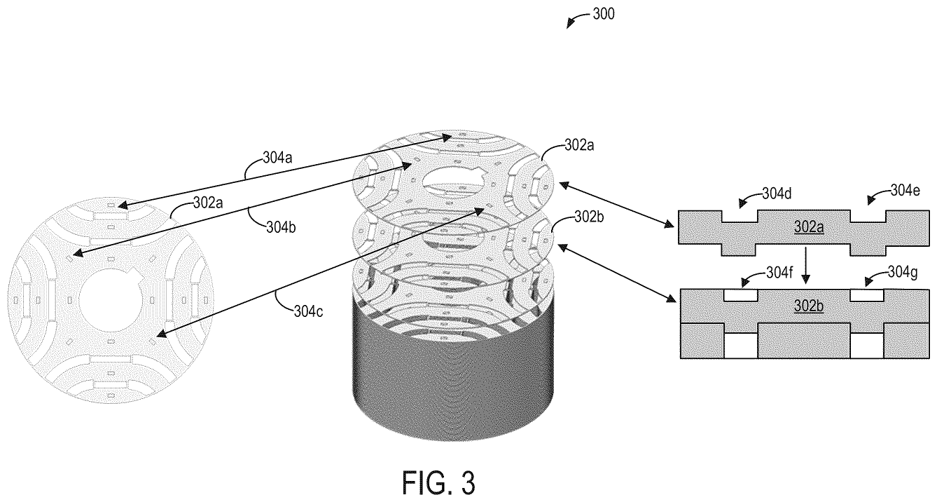

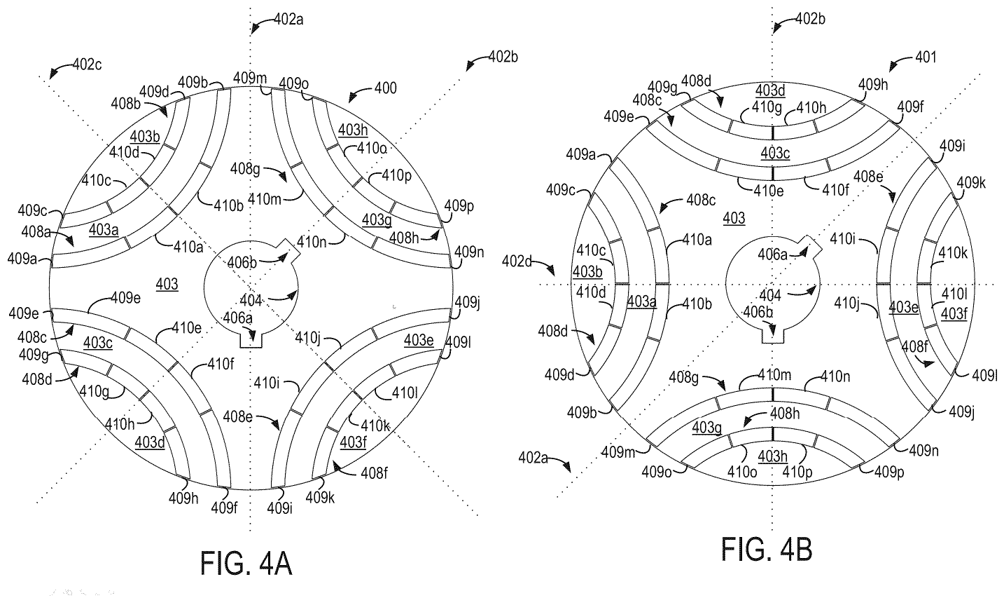

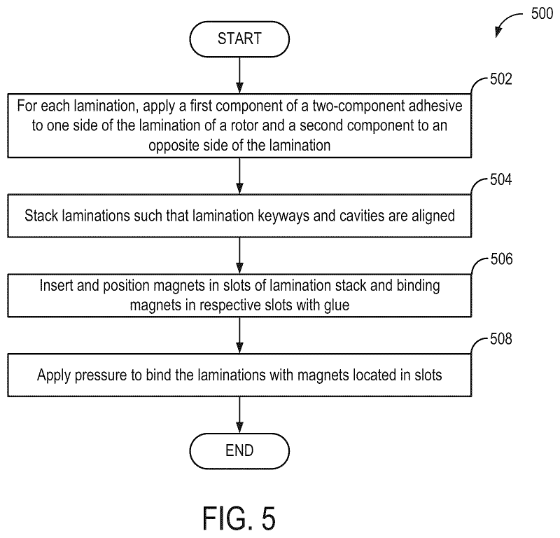

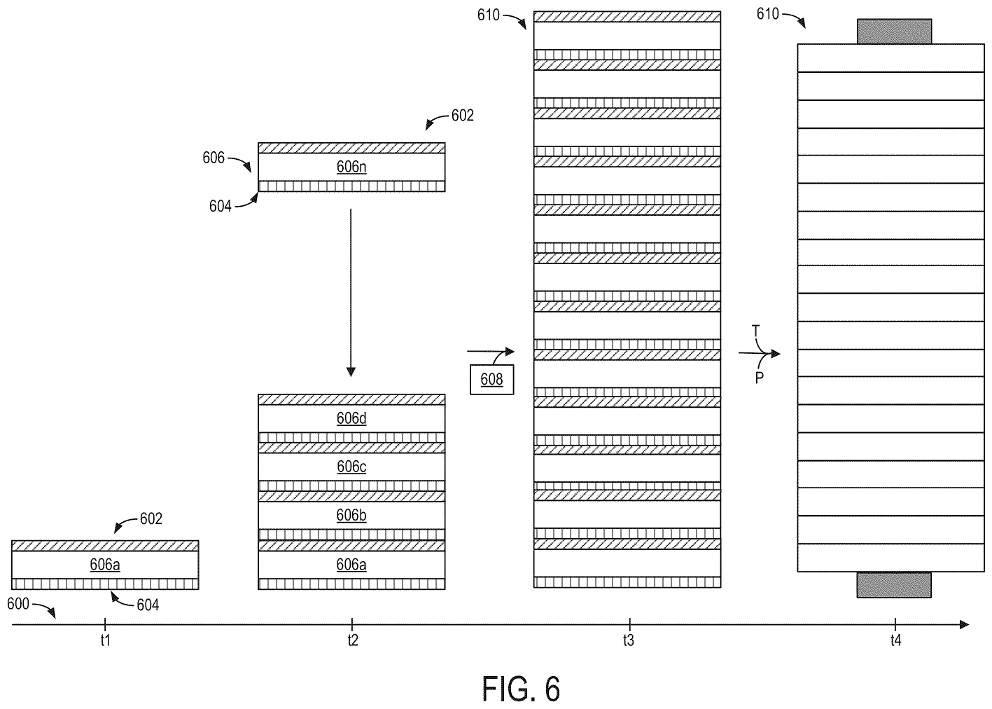

A vehicle system, including an electric motor, that communicatively couples various components of the vehicle system is shown in FIG. 1. FIGS. 2A & 2B illustrate a rotor lamination stack configured with slots for a plurality of magnets. FIG. 3 illustrates a rotor lamination stack configured with a plurality of punches. FIGS. 4A and 4B illustrate a topside and a bottom side of a lamination. A method for manufacturing the rotor lamination stack with a two-component adhesive is described in FIG. 5. A timing diagram that illustrates a timing sequence of a manufacturing process for assembling a rotor lamination stack is shown in FIG. 6.

FIG. 1 shows a schematic depiction of a vehicle system 100. The vehicle system 100 may include rear vehicle wheels 104, front vehicle wheels 106, a traction battery 108, and an electric drive system 120. The electric drive system 120 may include an electric motor 102 and an electric drive 118 electrically coupled to the electric motor 102. The electric drive 118 may include an inverter communicatively coupled to a control system 110 to control speed and torque of the electric motor 102. The inverter may be electrically coupled to an electrical power source wherein executable instructions are configured, stored, and executed in at least one memory by at least one processor of the inverter.

The control system 110 may include a controller 112 of a plurality of controllers that is communicatively coupled to a plurality of sensors 114 and a plurality of actuators 116. The control system 110 may receive information, for example via controller 112, from a plurality of sensors 114 and send control signals to a plurality of actuators 116 based on the information received. The plurality of sensors 114 may include a plurality of position sensors, a plurality of a motor phase current sensors, and the like, as one example. As another example, the plurality of actuators 116 may include an electrical actuator to adjust speed and torque of the electric motor 102. The controller 112 may receive input data from the various sensors, process the input data, and control the actuators in response to the processed input data based on executable instruction or code programmed therein corresponding to one or more routines.

The vehicle system 100 may derive propulsion power from the electric motor 102. In some embodiments, a lamination stack of a rotor of the electric motor 102 may not be configured with a plurality of laminations with punches that enable the laminations to interlock with other laminations. Instead, the lamination stack may be configured with a plurality of laminations without punches. In particular, the lamination stack is assembled by curing a two-component adhesive applied to each lamination when the plurality of laminations is mounted on top of each other to bind the plurality of laminations together. In the present disclosure, the electric motor 102 is mounted in a rear wheel drive configuration. Other embodiments of the present disclosure may utilize alternative configurations, such as employing electric motor 102 in a front wheel configuration or employing a configuration wherein the electric motor 102 is mounted to both the rear vehicle wheels 104 and the front vehicle wheels 106. The electric motor 102 may receive electrical power from a traction battery 108 to provide torque to rear vehicle wheels 104. In some embodiments, the electric motor 102 may be operated as a generator to provide electrical power to charge traction battery 108, for example, during a braking operation.

The electric motor 102 may include a gearbox integrated therein. Additionally or alternatively, the electric motor 102 may be coupled to an outside of a transmission/gearbox housing. The integrated gearbox may include a differential gear set and a planetary gear set for transmitting power from the electric motor 102 to the rear vehicle wheels 104. The electric motor 102 may also include at least one clutch. A controller in a designated control system (e.g., not including the control system 110) of the vehicle system 100 may send a signal to an actuator of the clutch to engage or disengage the clutch, so as to couple or decouple power transmission from the electric motor 102 to the rear vehicle wheels 104 or from the electric motor 102 to the front vehicle wheels 106. Additionally or alternatively, there may be multiple traction batteries configured to provide power to different driven wheels, wherein power to the wheels may be predicated based on traction at the wheels, driver demand, and other conditions. In one example, the vehicle system 100 includes an all-wheel drive vehicle system.

Similar to the control system 110, the designated control system described above may receive information from a plurality of sensors and send control signals to a plurality of actuators based on the information received. The plurality of sensors may include a battery level sensor, a clutch activation sensor, and the like, as one example. As another example, the plurality of actuators may include a clutch. The controller in the designated control system may receive input data from the various sensors, process the input data, and control the actuators in response to the processed input data based on executable instruction or code programmed therein corresponding to one or more routines.

An axis system 122 is provided in FIG. 1 for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

Turning now to FIG. 2A, it shows a lamination 200 of a lamination stack of a rotor. The rotor may be integrated in an existing electric motor, such as electric motor 102 of FIG. 1. The electric motor may include a rotor, which may be currently implemented in existing electric motor systems, and a stator (not shown). The lamination 200 may comprise a magnetic portion 216 including a plurality of segments and a plurality of punches 208, which is described below in FIG. 3, and a non-magnetic portion comprising a plurality of cavities. The lamination 200 may include a keyway 206 on an inner diameter 204 of the lamination which engages with keys on a rotor shaft (not shown).

The plurality of segments may include a first segment 216a, a second segment 216b, a third segment 216c, a fourth segment 216d, a fifth segment 216e, a sixth segment 216f, a seventh segment 216g, and an eighth segment 216h. The plurality of cavities may include a first cavity 210a, a second cavity 210b, a third cavity 210c, a fourth cavity 210d, a fifth cavity 210e, a sixth cavity 210f, a seventh cavity 210g, and an eighth cavity 210h. Each cavity may be generally arc-shaped and spaced apart from each other by one segment. Further, each cavity may include a slot that positions a magnet.

For example, the first cavity 210a may be spaced apart from the second cavity 210b by the first segment 216a, and vice versa. The third cavity 210c may be spaced apart from the fourth cavity 210d by the third segment 216c, and vice versa. The fifth cavity 210e may be spaced apart from the sixth cavity 210f by the fifth segment 216e, and vice versa. The seventh cavity 210g may be spaced apart from the eighth cavity 210h by the seventh segment 216g, and vice versa. Further, the first cavity 210a may include a first slot 212a that positions a first magnet 214a. The second cavity 210b may include a second slot 212b that positions a second magnet 214b. The third cavity 210c may include a third slot 212c that positions a third magnet 214c. The fourth cavity 210d may include a fourth slot 212d that positions a fourth magnet 214d. The fifth cavity 210e may include a fifth slot 212e that positions a fifth magnet 214c. The sixth cavity 210f may include a sixth slot 212f that positions a sixth magnet 214f. The seventh cavity 210g may include a seventh slot 212g that positions a seventh magnet 214g. The eighth cavity 210h may include an eighth slot 212h that positions an eighth magnet 214h.

FIG. 2B shows a rotor 201 that comprises a lamination stack 220 and a rotor shaft 222. The lamination stack 220 may comprise a plurality of laminations. In some embodiments, the lamination 200 described above with FIG. 2A may be the topmost lamination in the lamination stack 220. The lamination stack 220 may be assembled by stacking one lamination on top of another lamination such that the keyways (e.g., keyway 206) are aligned until all the laminations are stacked. In this way, cavities of the laminations may be stacked to create an enclosure, the enclosure may be a space, such as a cavities or slots. To elaborate, by stacking the plurality of laminations, a plurality of cavities is formed wherein each cavity includes a slot that may position a magnet of a plurality of magnets. As such, each of the first slot 212a, the second slot 212b, the third slot 212c, the fourth slot 212d, the fifth slot 212e, the sixth slot 212f, the seventh slot 212g, and the eighth slot 212h of the lamination stack 220 may enclose the first magnet 214a, the second magnet 214b, the third magnet 214c, the fourth magnet 214d, the fifth magnet 214e, the sixth magnet 214f, the seventh magnet 214g, and the eighth magnet 214h, respectively. In this way, the magnet may extend from one end of the rotor 201 to another end of the rotor 201.

FIG. 3 illustrates a lamination stack 300 of a rotor comprising a plurality of lamination stacks with a plurality of punches. The rotor may be integrated in an existing electric motor, such as electric motor 102 of FIG. 1. The electric motor may include a rotor, which may be currently implemented in existing electric motor systems. The laminations may be deformed by the punches to enable laminations to interlock with one another. In this way, concave regions of the punches of one lamination may interlock with convex regions of the punches of a different lamination. The plurality of punches may include a first punch 304a, a second punch 304b, a third punch 304c, a fourth punch 304d, a fifth punch 304c, a sixth punch 304f, and a seventh punch 304g. The first punch 304a, the second punch 304b, the third punch 304c, the fourth punch 304d, and a fifth punch 304c are located on a surface of a first lamination 302a of the lamination stack 300. The sixth punch 304f and the seventh punch 304g are located on a surface of a second lamination 302b of the lamination stack 300. The first lamination 302a and the second lamination 302b may be embodiments of the lamination 200 and are adjacently positioned within the lamination stack 300.

As described above in FIG. 2A, stacking the plurality of laminations creates cavities wherein magnets may fully or partially fill the cavities. In particular, the plurality of laminations may be stacked by engaging punches of adjacent laminations or rather, the punches of one lamination with the punches of another lamination. For example, the fourth punch 304d and the fifth punch 304c may be located on a portion of the surface of the first lamination 302a whereas the sixth punch 304f and the seventh punch 304g may be located on a portion of the surface of the second lamination 302b. In particular, the first lamination 302a may engage with the second lamination 302b by engaging the fourth punch 304d and the sixth punch 304f and engaging the fifth punch 304c and the seventh punch 304g. More specifically, convex portions of the fourth punch 304d and the fifth punch 304c may engage with the concave portions of the sixth punch 304f and the seventh punch 304g, respectively. In this way, the lamination stack 300 may be assembled.

Although the lamination stack 300 may be assembled by interlocking the punches of the laminations, introducing the punches may reduce the mechanical properties of the lamination, such that dropping the lamination may cause the lamination to break and/or interfere with the punch level. The fragility and case of deformability of the lamination when the lamination is deformed to form the punches may result in increased production costs and times due to careful handling of the laminations. The issues associated with deforming the lamination may be addressed by removing the punches and using a two-component adhesive that coats opposite sides of laminations without punches. In this way, the plurality of laminations may be coupled with each other.

FIGS. 4A and 4B illustrate embodiments of a topside 400 of a lamination with a first cavity pattern and a bottom side 401 of the lamination with a second cavity pattern that may be mounted during a manufacturing process to form a lamination stack of a rotor. The rotor fabricated from the plurality of laminations do not have windings or squirrel cage inductors integrated within the rotor. Each of the topside 400 and the bottom side 401 of the lamination include a magnetic portion that includes a plurality of segments as well as a non-magnetic portion that includes a plurality of cavities. The plurality of cavities of the lamination is arranged to form the first cavity pattern on the topside 400 and the second cavity pattern on the bottom side 401. The pattern lamination has a preferred magnetic circuit as well as a two-plane symmetry with regards to two orthogonal planes. Depending on the embodiment, the plurality of cavities may be fully filled or partially filled with magnets (e.g., permanent magnets).

The topside 400 of the lamination is shown in FIG. 4A and the bottom side 401 of the lamination is shown in FIG. 4B. Each of the topside 400 and bottom side 401 may comprise a magnetic portion 403 including a plurality of segments, a non-magnetic portion comprising a plurality of cavities, and a first keyway 406a and a second keyway 406b on an inner diameter 404. The first keyway 406a and the second keyway 406b engage and interlock with two keys of a rotor shaft (not shown). The first keyway 406a and the second keyway 406b are arranged with a relative angle that is not 90° or 180° between them. As an example, the first keyway 406a and the second keyway 406b may be arranged with a relative angle of 135° between them. The topside 400 of the lamination may have a first cavity pattern relative to a particular positioning of the first keyway 406a and the second keyway 406b and the bottom side may have a second cavity pattern relative to the same particular positioning of the first keyway and the second keyway.

Each keyway engages and interlocks with only one key of the rotor shaft, enabling the lamination stack to rotate, which in turns rotates the rotor. The plurality of segments may include a first segment 403a, a second segment 403b, a third segment 403c, a fourth segment 403d, a fifth segment 403e, a sixth segment 403f, a seventh segment 403g, and an eighth segment 403h. The plurality of cavities may include a first cavity 408a, a second cavity 408b, a third cavity 408c, a fourth cavity 408d, a fifth cavity 408e, a sixth cavity 408f, a seventh cavity 408g, and an eighth cavity 408h. Each cavity includes two peripheral ends and two slots wherein magnets are positioned. For example, the first cavity 408a includes a first peripheral end 409a, a second peripheral end 409b, a first slot 410a, and a second slot 410b. The second cavity 408b includes a third peripheral end 409c, a fourth peripheral end 409d, a third slot 410c, and a fourth slot 410d. The third cavity 408c includes a fifth peripheral end 409e, a sixth peripheral end 409f, a fifth slot 410c, and a sixth slot 410f.

The fourth cavity 408d includes a seventh peripheral end 409g, an eighth peripheral end 409h, seventh slot 410g, and an eighth slot 410h. The fifth cavity 408e includes a ninth peripheral end 409i, a tenth peripheral end 409j, a ninth slot 410i and a tenth slot 410j. The sixth cavity 408f includes an eleventh peripheral end 409k, a twelfth peripheral end 409l, an eleventh slot 410k, and a twelfth slot 410l. The seventh cavity 408g includes a thirteenth peripheral end 409m, a fourteenth peripheral end 409n, a thirteenth slot 410m, and a fourteenth slot 410n. The eighth cavity 408h includes a fifteenth peripheral end 4090, a sixteenth peripheral end 409p, fifteenth slot 4100, and a sixteenth slot 410p.

Each cavity may be generally arc-shaped and spaced apart from each other by one segment. As one example, the first cavity 408a may be spaced apart from the second cavity 408b by the first segment 403a, the third cavity 408c may be spaced apart from the fourth cavity 408d by the third segment 403c, the fifth cavity 408e may be spaced apart from the sixth cavity 408f by the fifth segment 403c, and the seventh cavity 408g may be spaced apart from the eighth cavity 408h by the seventh segment 403g.

Additionally, each cavity may comprise two peripheral ends that extend toward an outer surface of the topside 400. Two slots may be spaced between the two peripheral ends; the two slots being adjacently positioned within the cavity. One slot is contiguous with one of the peripheral ends and the other slot is contiguous with the other peripheral end. The two slots may enclose a permanent magnet of a plurality of permanent magnets of the lamination stack. The permanent magnets are magnetized before manufacturing of the lamination stack. For example, with respect to the first cavity 408a, the first slot 410a and the second slot 410b may be spaced between the first peripheral end 409a and the second peripheral end 409b. The first slot 410a is contiguous with the first peripheral end 409a and the second slot 410b is contiguous with the second peripheral end 409b.

In regards to the second cavity 408b, the third slot 410c and the fourth slot 410d may be spaced between the third peripheral end 409c and the fourth peripheral end 409d. The third slot 410c is contiguous with the third peripheral end 409c and the fourth slot 410d is contiguous with the fourth peripheral end 409d. Similarly, for the third cavity 408c, the fifth slot 410e and the sixth slot 410f may be spaced between the fifth peripheral end 409e and the sixth peripheral end 409f. The fifth slot 410e is contiguous with the fifth peripheral end 409e and the sixth slot 410f is contiguous with the sixth peripheral end 409f. With respect to the fourth cavity 408d, the seventh slot 410g and the eighth slot 410h may be spaced between the seventh peripheral end 409g and the eighth peripheral end 409h. The seventh slot 410g is contiguous with the seventh peripheral end 409g and the eighth slot 410h is contiguous with the eighth peripheral end 409h.

With respect to the fifth cavity 408e, the ninth slot 410i and the tenth slot 410j may be spaced between the ninth peripheral end 409i and the tenth peripheral end 409j. The ninth slot 410i is contiguous with the ninth peripheral end 409i and the tenth slot 410j is contiguous with the tenth peripheral end 409j. In regards to the sixth cavity 408f, the eleventh slot 410k and the twelfth slot 410l may be spaced between the eleventh peripheral end 409k and the twelfth peripheral end 409l. The eleventh slot 410k is contiguous with the eleventh peripheral end 409k and the twelfth slot 410l is contiguous with the twelfth peripheral end 409l. Similarly, for the seventh cavity 408g, the thirteenth slot 410m and the fourteenth slot 410n may be spaced between the thirteenth peripheral end 409m and the fourteenth peripheral end 409n. The thirteenth slot 410m is contiguous with the thirteenth peripheral end 409m and the fourteenth slot 410n is contiguous with the fourteenth peripheral end 409n. With respect to the eighth cavity 408h, the fifteenth slot 4100 and the sixteenth slot 410p may be spaced between the fifteenth peripheral end 4090 and the sixteenth peripheral end 409p. The fifteenth slot 4100 is contiguous with the fifteenth peripheral end 4090 and the sixteenth slot 410p is contiguous with the sixteenth peripheral end 409p.

As shown in FIG. 4A, the first keyway 406a is aligned with a first line 402a (e.g., a vertical centerline) and the second keyway 406b is aligned with a second line 402b. The second keyway 406b is positioned along the inner diameter 404 such that there is a relative angle of 45° between the first line 402a and the second keyway, and therefore, a relative angle of 45° between the first line 402a and the second line 402b. The centers of the plurality of cavities are aligned with one of the second line 402b and a third line 402c. Both of the second line 402b and the third line 402c are positioned such that there is a relative angle of 45° between the first line 402a and the second line or third line. Accordingly, a relative angle between a center of each cavity of the topside 400 and the first line 402a may be 45°. More specifically, the relative angle between the centers of each of the first cavity 408a, the second cavity 408b, the third cavity 408c, the fourth cavity 408d, the fifth cavity 408e, the sixth cavity 408f, the seventh cavity 408g, and the eighth cavity 408h and the first line 402a (e.g., vertical centerline) is 45°.

As shown in FIG. 4B, the first keyway 406a is aligned with the first line 402a, and the second keyway 406b is aligned with a second line 402b. From the bottom side 401, the first line 402a is not a vertical centerline. However, the second keyway 406b remains positioned along the inner diameter 404 such that there is a relative angle of 45° between the first line 402a and the second keyway, and therefore, a relative angle of 45° between the first line 402a and the second line 402b. The centers of the plurality of cavities are aligned with one of the second line 402b and a fourth line 402d. The fourth line 402d is positioned (e.g. horizontal centerline) such that there is a relative angle of 90° between the second line 402b and the fourth line. Accordingly, a relative angle between a center of one or more cavities and the second line 402b may be 0° or a relative angle between a center of one or more cavities and the fourth line 402d may be 90°. More specifically, the relative angle between the centers of each of the first cavity 408a, the second cavity 408b, the fifth cavity 408e, the sixth cavity 408f and the first line 402a is 90°. Also, the relative angle between the centers of each of the third cavity 408c, the fourth cavity 408d, the seventh cavity 408g, and the eighth cavity 408h and the third line 402c is 0°.

When comparing the topside 400 and the bottom side 401 of the lamination, the keyways and the plurality of cavities (e.g., cavity pattern) are positioned such that during the manufacturing process, it is not possible to stack the topside and the bottom side and match both of the cavity patterns and the keyways. The topside 400 has a first cavity pattern and the bottom side 401 has a second cavity pattern wherein the first cavity pattern differs from the second cavity pattern bottom side 401. In particular, the centers of the cavities in the first cavity pattern differ by a relative angle of 45° when compared with the centers of the cavities in the second cavity pattern.

It may be understood that the lamination described herein may differ from the lamination described herein without departing from the scope of the disclosure. In particular, the lamination may be one variant of a plurality of lamination variants. Other lamination variants may include different cavity patterns or positioning of the cavities as well as different positioning of the keyways, such as different relative angles between the two keyways.

A method 500 for manufacturing a lamination stack using a two-component adhesive is shown in FIG. 5. The lamination stack may comprise a plurality of laminations. The lamination stack and the plurality of laminations may be various embodiments of the lamination and the plurality of laminations illustrated in FIGS. 4A and 4B or other suitable lamination stacks and laminations. The method 500 may be implemented by one or more machines such as machines configured for coating adhesives, subjecting components to mechanical loads (e.g., pressure), supplying heat to components (e.g., subject components to a specific temperature), and assembly etc. The machines may include instructions stored in memory executable by a processor to implement the different steps. To elaborate, at least some of the method steps may be implemented as an automated machine process. However, in other examples, at least some of the steps may be implemented in response to user input or may be manually implemented via manufacturing personnel.

At 502, the method 500 includes for each lamination, applying a first component of a two component adhesive to one side of a lamination of a rotor and a second component to an opposite side of the lamination. The two-component adhesive may be a dielectric material comprising the first component and the second component. One of the first component and the second component may be an activator, which may act as a catalyst during curing of the two-component adhesive to increase the rate of the reaction. The activator may be activated when pressure is within a pre-determined threshold pressure and temperature is within a pre-determined threshold temperature. The activator may also have an activation temperature wherein the activation temperature of the activator is lower than a demagnetization temperature of the magnets. By applying pressure within the pre-determined pressure threshold and supplying heat to achieve a temperature within the pre-determined temperature threshold, the activator may be activated which initiates the polymerization reaction that results in curing of the two-component adhesive.

The two-component adhesive, and more specifically, the first component and the second component may be selected based on an ability of the material to increase mechanical robustness under static and dynamic behavior of the rotor and to ensure rotor rigidity under static and dynamic conditions. Additionally, the two-component adhesive is selected to increase the damping factor of the rotor, which may increase the dynamic performance of the rotor in a driveline and the robustness of the rotor while operating under dynamic conditions. In particular, the two component adhesive is selected such that fretting of adjacent laminations of the lamination stack and breakage of laminations are reduced or eliminated. For example, the first component may be 4,4′-(Propane-2,2-diyl)diphenol (or Bisphenol A), and the like. For example, the second component may be 2-(Chloromethyl) oxirane (or glycidyl chloride), and the like.

In some embodiments, an automated system may cause machinery to coat one side of the lamination with the first component and the other side of the lamination with the second component. The machinery may enable an even layer of the first component to be applied to one side of the lamination and an even layer of the second component to be applied to the other side of the lamination. In this way, a uniform amount of the first component and the second component may be located at an interface (e.g., an interface between the first component and the second component) between a pair of adjacent laminations, which may enable polymerization of the first component and second component during curing of the two-component adhesive. The automated system may cause the machinery to coat each of the laminations used to assemble the lamination stack. The number of laminations included in the lamination stack may vary by embodiment. For example, in one embodiment, 450 laminations that are approximately 1 mm in thickness may be included in the lamination stack. The laminations may be coated with approximately 10 μm of each of the first component and the second component of the two-component adhesive.

In other embodiments, the plurality of laminations is blanked from a pre-coated metal band with a first component of the two-component adhesive on one side and with the second component of the two-component adhesive on another side. In this way, the plurality of lamination can be coated with the first component and the second component (e.g., approximately 10 μm) of the two-component adhesive without applying the first component and the second component to each lamination of the plurality of laminations individually.

At 504, the method 500 stacking laminations such that keyways and cavities are aligned. The automated system may cause machinery to align keyways of the lamination in addition to cavities of the laminations. Each lamination of the lamination stack has a same pre-determined cavity pattern and pre-determined keyway positioning. As described herein above with respect to FIGS. 4A and 4B, the pre-determined cavity pattern of a topside of each lamination differs from the pre-determined cavity pattern of a bottom side of each lamination. More specifically, a positioning of the plurality of cavities (or cavity pattern) relative to a first keyway and a second keyways differentiates a topside of a lamination from a bottom side of the lamination (e.g., relative angles relative to a vertical centerline). Lamination stacks may be constructed from laminations wherein the cavity pattern and keyway positioning of each lamination is the same (e.g., the same lamination variant) and each lamination is stacked such that the topside and bottom side of each lamination is facing the same direction.

In particular, a set of instructions may enable the machinery to align the first cavity pattern (e.g., FIG. 4A) of each lamination in the lamination stack. Or rather, for a pair of adjacent laminations comprising a first lamination and a second lamination, the set of instructions may enable the machinery to align a plurality of cavities of the first lamination with a plurality of cavities of a second lamination. For each pair of adjacent laminations, the set of instructions may also enable the machinery to align the first keyway of the first lamination with the first keyway of the second lamination and align the second keyway of the first lamination with the second keyway of the second lamination. Since both the first lamination and the second lamination have the same cavity pattern and positioning of the keyways and the topsides of the first lamination and the second lamination are facing the same direction, voids wherein the plurality of magnets may be inserted are created when stacking the first lamination and the second lamination.

It may be noted that the same lamination may be included in another pair of adjacent laminations depending on the stacking order of the respective lamination. In other words, since a fourth lamination is in contact with both of the third lamination and the fifth lamination in the lamination stack, a first pair of adjacent laminations may include the third lamination and the fourth lamination and a second pair of adjacent laminations may include the fourth lamination and the fifth lamination. As such, the cavity pattern and keyway positioning of the fourth lamination matches the cavity pattern when mounted and keyway positioning of the third lamination and the cavity pattern and keyway positioning of the fourth lamination stack matches the cavity pattern and keyway positioning of the fifth lamination when mounted.

At 506, the method 500 includes inserting and positioning magnets in slots of a lamination stack and binding magnets in respective slots with glue. The automated system may cause machinery to align the magnets and position the magnets within the slots. The automated system may further cause machinery to apply glue to the slots such that the magnet is in contact with the glue and the glue is in contact with the slot. In this way, the plurality of permanent magnets may be cemented in position within the slots of the plurality of cavities. In some embodiments, the glue may be a silicone rubber or another suitable adhesive and the magnets are permanent magnets that have already been magnetized.

At 508, the method 500 includes applying pressure to bind the laminations with magnets located in the slots. The automated system may cause machinery to apply a mechanical load such that the laminations are subjected to a pre-determined pressure. For example, 10 MPa may be applied to the lamination stack while being subjected to heat (e.g. at a specific temperature). In particular, the lamination stack may be maintained at a temperature of 50° C. to 60° C. for approximately 180-300 seconds as pressure is being applied to the stack. In some embodiments, heat may be supplied to the lamination stack with a microwave. In this way, heat may be supplied to the rotor lamination stack without resulting in high energy consumption. Other embodiments may utilize alternative means to supply heat to the lamination stack.

By applying a high pressure with a mechanical load and supplying heat to achieve pre-determined temperature, the activator may be activated when the pressure is within the pre-determined pressure threshold and the temperature is within the pre-determined temperature threshold. In turn, the activator may cause polymerization of the first component and the second component, which binds pairs of adjacent laminations together. Additionally, the heat supplied when achieving the activation temperature may facilitate curing of the adhesive used to position the magnets. Each pair of adjacent laminations may be bonded together in response to the pressure being within the pre-determined pressure threshold and the temperature being within the pre-determined temperature threshold since each of the laminations are coated with the two-component adhesive.

Since the activator is pressure-activated, the two-component adhesive may be cured at relatively low temperatures (e.g., close to room temperature) in relatively short time frames (e.g., less than ten minutes). In this way, the process may fabricate a lamination stack that is a solid, single and indivisible component in shorter time frames without subjecting the permanent magnets to temperatures that may decrease the magnetic parameters of the permanent magnets. As such, the permanent magnets are not damaged and the performance efficiency of the rotor may not be hindered. Additionally, since the first component and second component enable the lamination stack to be assembled based on structural bonding between the first component and second component, the occurrence of fretting between adjacent laminations may be reduced. The method 500 then ends.

FIG. 6 illustrates a timing sequence for a manufacturing process of a lamination stack according to the embodiments described herein. At t1, a time scale 600 includes coating a first lamination 606a of a plurality of laminations 606 with a first component 602 and a second component 604 of a two-component adhesive. One side of the first lamination 606a is coated with the first component 602 and another side of the lamination is coating with the second component 604. As described above, one of the first component 602 and the second component 604 may be an activator that is pressure- and temperature-activated when a pre-determined pressure threshold and a pre-determined temperature threshold is achieved. The first lamination 606a may be a bottommost lamination in a lamination stack 610. In other embodiments, the first lamination may be blanked from a pre-coated metal band with the first component 602 of the two-component adhesive on one side and with the second component 604 of the two-component adhesive on another side.

As shown on the time scale 600, the process further includes coating additional laminations in the plurality of laminations 606 with the first component 602 and the second component 604 at t2. After application of the two-component adhesive, or rather, after applying each of the first component 602 and the second component 604 to the respective lamination, the respective lamination is stacked on top of another lamination until all the laminations have been mounted. For example, after coating a second lamination 606b with the first component 602 and the second component 604, the second lamination is mounted on top of the first lamination 606a such that the first component 602 of the first lamination is in contact with the second component 604 of the second lamination and the two keyways (not shown) of the first lamination and the second lamination are aligned. In this way, an interface between a first pair of adjacent laminations, or rather the first lamination 606a and the second lamination 606b enables a polymerization reaction to occur between the first component 602 coating the first lamination and the second component 604 coating the second lamination.

Similarly, after coating a third lamination 606c with the first component 602 and the second component 604, third lamination is mounted on top of the second lamination 606b such that the first component of the second lamination is in contact with the second component of the third lamination and the two keyways (not shown) of the second lamination and the third lamination are aligned, the second lamination may be stacked on top of the first lamination 606a. Accordingly, an interface wherein the polymerization reaction occurs is achieved between the second lamination 606b and the third lamination, or rather, the first component of the second lamination and the second component of the third lamination. The process of coating the respective laminations may be repeated for a fourth lamination 606d, a nth lamination 606n, and the remaining laminations. In another embodiment, similar to the first lamination 606a, the remaining laminations of the plurality of laminations 606 may blanked from the pre-coated metal band with the first component 602 of the two-component adhesive on one side and with the second component 604 of the two-component adhesive on another side. After being blanked from the pre-coated metal band, the plurality of laminations 606 may be similarly stacked one by one as described above to ensure that the cavities of pairs of adjacent laminations and two keyways are aligned and to ensure that the first component 602 and the second component 604 of pairs of adjacent laminations are in contact.

After the plurality of laminations 606 have been mounted on top of one another to assemble a lamination stack 610, at time t3, the time scale 600 includes positioning a plurality of magnets 608 within the slots of the plurality of laminations 606 and cementing the magnets in the slots of the cavities with an adhesive. As described above, the plurality of magnets are permanent magnets that have already been magnetized. In some embodiments, the adhesive may be silicon rubber. At t4, the time scale 600 includes applying a mechanical load with a pressure P and a temperature T to the lamination stack 610 to cure the two-component adhesives coating each of the plurality of laminations 606. The lamination stack 610 may be exposed to a temperature T of 50° C. to 60° C. and a pressure P of around 10 MPa, for example, for approximately 180 seconds to 300 seconds. By utilizing a lower temperature for temperature T (e.g., room temperature), the plurality of magnets 608 may not be demagnetized during the curing process. In this way, each pair of adjacent laminations may be bonded together with the cured two-component adhesive to yield a single, indivisible lamination stack 610.

The technical effect of assembling a lamination stack with a manufacturing process based on a two-component adhesive comprising a first component and a second component that are activated and cured at higher pressures and lower temperatures is that the structural properties of the cured two-component adhesive enables the rotor to have suitable stiffness and behavior under static and dynamic conditions without compromising the magnetic parameters of the plurality of magnets inserted within the lamination stack.

The disclosure also provides support for a method for manufacturing a lamination stack, comprising: for each lamination of a plurality of laminations, applying a first component of a two-component adhesive to one side of a lamination of a rotor and a second component to an opposite side of the lamination, stacking the plurality of laminations such that keyways and cavities of each of the plurality of laminations are aligned to assemble the lamination stack, inserting and positioning magnets in slots of the lamination stack and binding the magnets in their respective slots with glue, and applying pressure and heat to bind the plurality of laminations together. In a first example of the method, the two-component adhesive is a dielectric material. In a second example of the method, optionally including the first example, one of the first component and the second component is an activator. In a third example of the method, optionally including one or both of the first and second examples, the activator is activated when pressure is within a pre-determined threshold pressure and temperature is within a predetermined threshold temperature.

In a fourth example of the method, optionally including one or more or each of the first through third examples, an activation temperature of the activator is lower than a demagnetization temperature of the magnets. In a fifth example of the method, optionally including one or more or each of the first through fourth examples, the lamination stack comprises the plurality of laminations wherein each lamination has a same pre-determined cavity pattern and pre-determined keyway positioning. In a sixth example of the method, optionally including one or more or each of the first through fifth examples, a pre-determined cavity pattern of a topside of each lamination differs from a pre-determined cavity pattern of a bottom side of each lamination.

The disclosure also provides support for an electric motor system, comprising: a stator, and a rotor comprising a shaft, a flange, and a lamination stack comprising a plurality of laminations wherein a topside of each lamination has a first cavity pattern and a bottom side of each lamination has a second cavity pattern that differentiates the topside from the bottom side. In a first example of the system, each lamination comprises a plurality of cavities, a plurality of segments, a first keyway, and a second keyway and a positioning of the plurality of cavities relative to the first keyway and the second keyway differentiates the topside from the bottom side. In a second example of the system, optionally including the first example, the plurality of laminations does not include punches and the first keyway and the second keyway such that a relative angle between the first keyway and the second keyway is not 90° or 180°. In a third example of the system, optionally including one or both of the first and second examples, each cavity is generally arc-shaped and each cavity comprises two peripheral ends that extend toward an outer surface of a lamination and two slots that are spaced between the two peripheral ends, the two slots being adjacently positioned within a cavity and enclosing permanent magnets of a plurality of permanent magnets.

In a fourth example of the system, optionally including one or more or each of the first through third examples, each cavity is spaced apart from another cavity by a segment of the plurality of segments, and for a respective cavity, one slot is contiguous with one of the peripheral ends and another slot is contiguous with the other peripheral end. In a fifth example of the system, optionally including one or more or each of the first through fourth examples, centers of one or more cavities of the topside are positioned with respect to a vertical centerline of the topside such that there is a relative angle of 45° between a center of the one or more cavities and the vertical centerline of the topside. In a sixth example of the system, optionally including one or more or each of the first through fifth examples, centers of one or more cavities of the bottom side are positioned with respect to a vertical centerline of the bottom side such that there is a relative angle of either 0° or 90° between a center of the one or more cavities and the vertical centerline of the bottom side. In a seventh example of the system, optionally including one or more or each of the first through sixth examples, a cured two-component adhesive binds the plurality of laminations to form the lamination stack.

The disclosure also provides support for a method, comprising: coating each lamination of a plurality of laminations with a first component and a second component of a two-component adhesive, the first component being coated on one side of a lamination and the second component being coated on another side of the lamination, mounting the plurality of laminations such that for each pair of adjacent laminations, the first component of a first lamination is in contact with the second component of a second lamination to assemble a lamination stack, inserting and positioning a plurality of permanent magnets into slots of a plurality of cavities of each lamination and cementing the plurality of permanent magnets in position within the slots, and applying a mechanical load and temperature to the lamination stack to cure the two-component adhesive and bind the plurality of laminations together. In a first example of the method, mounting the plurality of laminations such that for each pair of adjacent laminations, the first component of the first lamination is in contact with the second component of the second lamination to assemble the lamination stack comprises: for each pair of adjacent laminations, aligning a first keyway of the first lamination with a first keyway of the second lamination, aligning a second keyway of the first lamination with a second keyway of the second lamination, and aligning a plurality of cavities of the first lamination with a plurality of cavities of the second lamination.

In a second example of the method, optionally including the first example, a same lamination is included in a first pair of adjacent laminations and a second pair of adjacent laminations depending on stacking order of the plurality of laminations and wherein the plurality of permanent magnets is cemented in place within the slots with a silicon rubber or another suitable adhesive. In a third example of the method, optionally including one or both of the first and second examples, applying the mechanical load to the lamination stack to cure the two-component adhesive and bind the plurality of laminations together comprises applying the mechanical load to achieve a pressure of 10 MPa and maintaining a temperature of 50° C. to 60° C. for approximately 180 seconds to 300 seconds. In a fourth example of the method, optionally including one or more or each of the first through third examples, the plurality of laminations is blanked from a pre-coated metal band with the first component of the two-component adhesive on one side and with the second component of the two-component adhesive on another side.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

FIGS. 1-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

As used herein, the terms “approximately” and “substantially” are construed to mean plus or minus five percent of the range, unless otherwise specified.

1. A method for manufacturing a lamination stack, comprising:
for each lamination of a plurality of laminations, applying a first component of a two-component adhesive to one side of a lamination of a rotor and a second component to an opposite side of the lamination;
stacking the plurality of laminations such that keyways and cavities of each of the plurality of laminations are aligned to assemble the lamination stack;
inserting and positioning magnets in slots of the lamination stack and binding the magnets in their respective slots with glue; and
applying pressure and heat to bind the plurality of laminations together.

2. The method of claim 1, wherein the two-component adhesive is a dielectric material.

3. The method of claim 1, wherein one of the first component and the second component is an activator.

4. The method of claim 3, wherein the activator is activated when pressure is within a pre-determined threshold pressure and temperature is within a predetermined threshold temperature.

5. The method of claim 4, wherein an activation temperature of the activator is lower than a demagnetization temperature of the magnets.

6. The method of claim 1, wherein the lamination stack comprises the plurality of laminations wherein each lamination has a same pre-determined cavity pattern and pre-determined keyway positioning.

7. The method of claim 1, wherein a pre-determined cavity pattern of a topside of each lamination differs from a pre-determined cavity pattern of a bottom side of each lamination.

8. An electric motor system, comprising:
a stator; and
a rotor comprising a shaft, a flange, and a lamination stack comprising a plurality of laminations wherein a topside of each lamination has a first cavity pattern and a bottom side of each lamination has a second cavity pattern that differentiates the topside from the bottom side.

9. The electric motor system of claim 8, wherein each lamination comprises a plurality of cavities, a plurality of segments, a first keyway, and a second keyway and a positioning of the plurality of cavities relative to the first keyway and the second keyway differentiates the topside from the bottom side.

10. The electric motor system of claim 9, wherein the plurality of laminations does not include punches and the first keyway and the second keyway such that a relative angle between the first keyway and the second keyway is not 90° or 180°.

11. The electric motor system of claim 9, wherein each cavity is generally arc-shaped and each cavity comprises two peripheral ends that extend toward an outer surface of a lamination and two slots that are spaced between the two peripheral ends, the two slots being adjacently positioned within a cavity and enclosing permanent magnets of a plurality of permanent magnets.

12. The electric motor system of claim 11, wherein each cavity is spaced apart from another cavity by a segment of the plurality of segments, and for a respective cavity, one slot is contiguous with one of the peripheral ends and another slot is contiguous with the other peripheral end.

13. The electric motor system of claim 11, wherein centers of one or more cavities of the topside are positioned with respect to a vertical centerline of the topside such that there is a relative angle of 45° between a center of the one or more cavities and the vertical centerline of the topside.

14. The electric motor system of claim 11, wherein centers of one or more cavities of the bottom side are positioned with respect to a vertical centerline of the bottom side such that there is a relative angle of either 0° or 90° between a center of the one or more cavities and the vertical centerline of the bottom side.

15. The electric motor system of claim 8, wherein a cured two-component adhesive binds the plurality of laminations to form the lamination stack.

16. A method, comprising:
coating each lamination of a plurality of laminations with a first component and a second component of a two-component adhesive, the first component being coated on one side of a lamination and the second component being coated on another side of the lamination;
mounting the plurality of laminations such that for each pair of adjacent laminations, the first component of a first lamination is in contact with the second component of a second lamination to assemble a lamination stack;
inserting and positioning a plurality of permanent magnets into slots of a plurality of cavities of each lamination and cementing the plurality of permanent magnets in position within the slots; and
applying a mechanical load and temperature to the lamination stack to cure the two-component adhesive and bind the plurality of laminations together.

17. The method of claim 16, wherein mounting the plurality of laminations such that for each pair of adjacent laminations, the first component of the first lamination is in contact with the second component of the second lamination to assemble the lamination stack comprises:
for each pair of adjacent laminations, aligning a first keyway of the first lamination with a first keyway of the second lamination;
aligning a second keyway of the first lamination with a second keyway of the second lamination; and
aligning a plurality of cavities of the first lamination with a plurality of cavities of the second lamination.

18. The method of claim 17, wherein a same lamination is included in a first pair of adjacent laminations and a second pair of adjacent laminations depending on stacking order of the plurality of laminations and wherein the plurality of permanent magnets is cemented in place within the slots with a silicon rubber or another suitable adhesive.

19. The method of claim 16, wherein applying the mechanical load to the lamination stack to cure the two-component adhesive and bind the plurality of laminations together comprises applying the mechanical load to achieve a pressure of 10 MPa and maintaining a temperature of 50° C. to 60° C. for approximately 180 seconds to 300 seconds.

20. The method of claim 16, wherein the plurality of laminations is blanked from a pre-coated metal band with the first component of the two-component adhesive on one side and with the second component of the two-component adhesive on another side.
